(19) United States
(12) Patent Application Publication
(10) Pub. No.: US 2005/0088351 A1
(43) Pub. Date: Apr. 28, 2005

(54) Antenna having a protection film and method of protecting the antenna

(76) Inventors: Lung-Sheng Tai, Tu-Chen (TW); Yun-Lung Ke, Tu-Chen (TW); Chen-Ta Hung, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/971,667

(22) Filed: Oct. 22, 2004

(30) Foreign Application Priority Data
Oct. 24, 2003 (TW) 92129552

(51) Int. Cl. H01Q 1/24

(52) U.S. Cl. 343/702; 343/846

(57) ABSTRACT

An antenna (1) includes a printed circuit board (10), a first radiation element (11), a second radiation element (12), a ground portion (13), a feeder cable (14), and an extending ground element (15) including an assistant plate (150) electrically connected to the ground portion and provided for increasing the area of the ground portion and a protection film (151) which covers the whole surface of the assistant plate and is provided for preventing the antenna from oxidization.

### BACKGROUND OF THE INVENTION

1. Field of the Invention

The present invention relates generally to an antenna, and more particularly to an antenna having a protection film and a method of protecting the same.

2. Description of the Prior Art

In recent years, various kinds of antennas dedicated to portable telephones or mobile computers (hereinafter, abbreviated as portable terminal in general) have become more and more compact except large-scale antennas for use at base stations or in satellite broadcasting. In accordance with the application, microstrip antennas have become more and more widely used because of their compact structure, light weight and low cost. As well known, a conventional microstrip antenna usually comprises a radiation portion, a ground portion, a dielectric substrate and a feeder cable. Generally, the electrical performance of a conventional ground portion is not desirable, so that the conventional antennas will generate a great loss, except for making some improvement to the ground portion. In order to improve the ground effect and reduce the antenna loss, many methods are proposed, for example, varying the conductivity of the ground portion, increasing the area of the ground portion, or using a metal plane or a metal net instead of actual ground, and so on.

A planar inverted-F antenna used with a LCD for increasing the area of the ground portion is disclosed in U.S. Patent Application Publication No. 2002/0171588. The inverted-F antenna 1 comprises a ground surface 14 and a radiation element 13. The radiation element 13 comprises a feed 11 and the ground surface 14 comprises a grounding section 12. In addition, the inverted-F antenna 1 also comprises an extended ground surface 15 that connects to the ground surface 14 and is bent to subtend an angle with the ground surface 14. The extended ground surface 15 provides a better grounding effect for the inverted-F antenna 1. In use, when the antenna 1 is attached to the LCD, the extended ground surface 15 is on the back side of the LCD and is stacked or fixed onto the back surface of the LCD so that the antenna 1 can be easily accommodated into the narrow space available in the LCD panel. However, the application of the antenna of the prior art is limited because not every electronic device has a conducting plate big enough like a LCD. For example, the antenna cannot use with a wireless local area network (WLAN) product, such as a WLAN card. Even though the electronic device has a LCD, the extended ground surface 15 is not flexible enough to fit for all kinds of LCDs. Moreover, the extended ground surface 15 is exposed in the open air, so that the antenna 1 is easily oxygenated, thus the antenna performance is adversely affected and the life of the antenna 1 is reduced.

Hence, in this art, an antenna having a flexible extending ground element and a protection film and a method of protecting the same to overcome the above-mentioned disadvantages of the prior art will be described in detail in the following embodiments.

### BRIEF SUMMARY OF THE INVENTION

A primary object, therefore, of the present invention is to provide an antenna having a flexible extending ground element.

Another object, therefore, of the present invention is to provide an antenna having a protection film for preventing the antenna from oxygenation.

A third object, therefore, of the present invention is to provide a protecting method of the antenna.

In order to implement the above objects and overcome the above-identified deficiencies in the prior art, the antenna of the present invention used with an electronic device comprises a main body comprising a printed circuit board (PCB), a first radiation element, a second radiation element, a ground portion and a feeder cable and an extending ground element comprising an assistant plate electrically connected to the ground portion and provided for improving the ground effect and a protection film which covers the surface of the assistant plate and is provided for protecting the extending ground element, further more, for protecting the antenna. The method of the present invention comprises assembling the main body of the antenna in the electronic device which is having a corresponding circuit and a corresponding fixing space, choosing the assistant plate, electrically connecting the assistant plate and the ground portion, covering the surface of the assistant plate with a protection film in order to prevent the antenna from oxygenation.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a top view of a preferred embodiment of an antenna in accordance with the present invention.

FIG. 2 is a cross-sectional view taken along line 2-2 of FIG. 1.

### DETAILED DESCRIPTION OF THE INVENTION

Reference will now be made in detail to a preferred embodiment of the present invention.

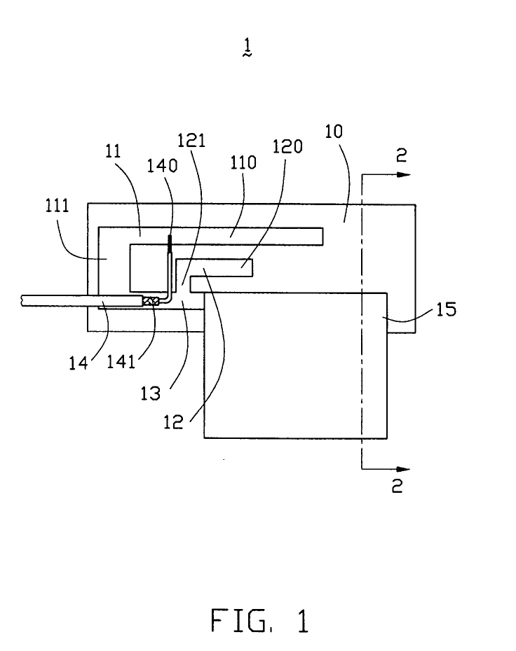

Referring to FIG. 1, an antenna 1 according to the present invention comprises a main body (not labeled) comprising a printed circuit board (PCB) 10, a first radiation element 11, a second radiation element 12, a ground portion 13 and a feeder cable 14 and an extending ground element 15.

The ground portion 13 is a long strip settled on the PCB 10 and extends from a left edge (not labeled) to a right edge (not labeled) of the PCB. The first radiation element 11 is L-shaped and comprises a first arm 110 and a first leg 111. The first arm 110 is parallel to the ground portion 13. The first leg 111 is perpendicular to the ground portion 13 and connects a left end of the first arm 110 and a left end of the ground portion 13. The second radiation element 12 is L-shaped and comprises a second arm 120 and a second leg 121. The second arm 120 is parallel to the ground portion 13 and situated between the first arm 110 and the ground portion 13. The second leg 121 is perpendicular to the ground portion 13 and connects a left end of the second arm 120 and the ground portion 13. The second leg 121 is adjacent to the first leg 111. The two L-shaped radiation elements 11 and 12 face to the same direction and are coplanar with each other and also with the ground portion 13. The radiation elements 11 and 12 and the ground portion 13 cooperatively form two planar inverted-F antennas (PIFAs) operating in different frequency bands. The feeder cable 14 is settled on the left end of the ground portion 13 and comprises an inner conductor 140 and an outer conductor 141. The inner conductor 140 is welded on the first arm 110 and the outer conductor 141 is welded on the ground portion 13. The welding point on the first arm 110 is a feed point (not labeled). The antenna input impedance of the antenna 1 can be tuned by varying the location of the feed point.

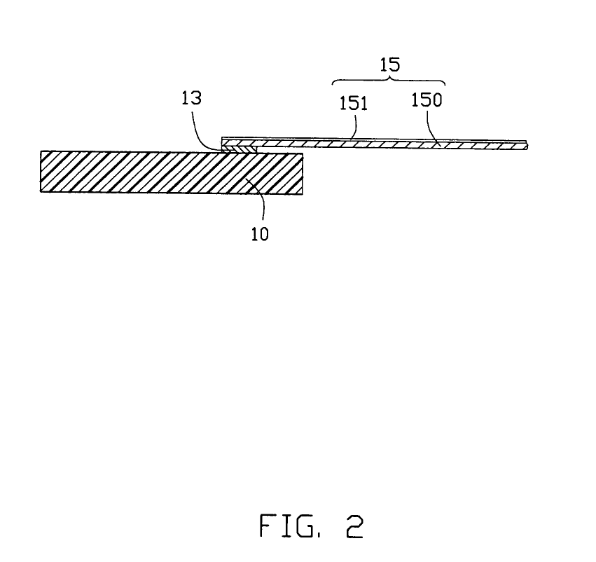

Referring to FIGS. 1-2, the extending ground element 15 is rectangular and comprises an assistant plate 150 and a protection film 151. The extending ground element 15 is positioned at a right portion of the ground portion 13 and is parallel to the ground portion 13. The ground portion 13 extends from the upper surface (not labeled) of the ground portion 13. The assistant plate 150 can be made of copper, aluminium or other metal materials. The assistant plate 150 can be directly welded on the ground portion 13 or connected with the ground portion 13 by a conductive pastern or by other means. Adding the assistant plate 150 increases the effective area of the ground portion 13 and improves the ground conductive effect, thus improves the antenna performance. The protection film 151 is of the same size and shape of the assistant plate 150 and covers the whole upper surface (not labeled) of the assistant plate 150 which is exposed in the air by galvanization, painting, paste and the like. Adding the protection film 151 can prevent the assistant plate 150 from oxygenation in the air. The protection film 151 can be made of capton tape, mylar, conductive fabric and some other dielectric materials.

The present invention is not limited to the preferred embodiment and may be modified variously. For instance, the main body described in the above-mentioned preferred embodiment is a PIFA. Besides, a microstrip antenna or any other type of printed antennas having the similar structure to the main body can also be protected by adding a protection film 151. The shape and size of the extending ground element 15 can be tuned according to an application space. Generally, the antenna 1 is fixed in a corresponding fixing space (not shown) in an electronic device (not shown). The corresponding fixing space is divided into two parts. One is a main space which is occupied by the main body of the antenna 1 and the other is a spare space. If the electronic device has a larger spare space, the extending ground element 15 can be designed larger. If the electronic device has a smaller spare space, the extending ground element 15 can be designed smaller. Additionally, the extending ground element 15 of the present invention is flexible enough to be bent to any shape according to the spare space rather than a rectangular only, thus, the interior space of the electronic device is utilized more efficiently and the ground effect of the antenna 1 is obviously improved.

The antenna 1 having the above structure is protected by means of example as follows:

First, preparing the main body, and making the radiation elements 11 and 12 and the ground portion 13 electrically coupled with a corresponding circuit (not shown) in the electronic device by the feeder cable 14. Second, choosing the assistant plate 150. The surface area of the assistant plate 150 is required not more than that of the interior spare space in the corresponding fixing space in the electronic device. Third, electrically connecting the chosen assistant plate 150 and the ground portion 13 by weld, conductive paste, or other methods. The assistant plate 150 can be made of copper, aluminium or some other metal materials. Forth, covering the upper surface of the assistant plate 150 which is exposed in the air with a protection film 151 in order to prevent the assistant plate 150 thus the antenna from oxygenation. The protection film 151 can be made of capton tape, mylar, conductive fabric and the like.

It is to be understood, however, that even though numerous characteristics and advantages of the present invention have been set forth in the foregoing description, together with details of the structure and protecting method of the invention, the disclosure is illustrative only, and changes may be made in detail, especially in matters of shape, size, and arrangement of parts or protecting method within the principles of the invention to the full extent indicated by the broad general meaning of the terms in which the appended claims are expressed.

1. An antenna, comprising:
a printed circuit board;
a ground portion disposed on the printed circuit board;
a radiation element connected with the ground portion;
a feeder cable comprising an inner conductor electrically connected with the radiation element and an outer conductor electrically connected with the ground portion; and
an extending ground element extending from the ground portion and comprising an assistant plate adapted for increasing the ground area and a protection film provided for protecting the assistant plate.

2. The antenna as claimed in claim 1, wherein the radiation element is coplanar with the ground portion.

3. The antenna as claimed in claim 1, wherein the radiation element comprises a first radiation element and a second radiation element resonating in different frequency bands.

4. The antenna as claimed in claim 2, wherein the first and the second radiation elements are both L-shaped and coplanar with each other.

5. The antenna as claimed in claim 1, wherein the first and the second radiation elements extend in the same direction.

6. The antenna as claimed in claim 1, wherein the extending ground element is parallel to the ground portion.

7. The antenna as claimed in claim 1, wherein the assistant plate is electrically connected with the ground portion.

8. The antenna as claimed in claim 1, wherein the protection film covers the whole upper surface of the assistant plate.

9. The antenna as claimed in claim 1, wherein the extending ground element is flexible.

10. An antenna used with an electronic device, comprising:
a main body comprising a printed circuit board, a radiation element, a ground portion and a feeder cable; and
an extending ground element which is electrically connected with the main body for increasing an effective ground area of the antenna and is flexible to be bent.

11. The antenna as claimed in claim 10, wherein the extending ground element can be bent for compliance with an interior space of the electronic device.

12. The antenna as claimed in claim 10, wherein the extending ground element comprises an assistant plate for increasing the ground area of antenna and a protection film for preventing the antenna from oxygenation.

13. The antenna as claimed in claim 10, wherein the antenna can be operated at two different frequency bands.

14. A protection method of an antenna used with an electronic device which comprises a corresponding circuit, comprising:
preparing a main body of the antenna;
providing an assistant plate;
electrically connecting the assistant plate and the main body; and
covering an upper surface of the assistant plate with a protection film.

15. The protection method as claimed in claim 14, wherein the main body comprises a first and a second radiation elements, a feeder cable, a printed circuit board and a ground portion, the radiation elements and the ground portion being electrically connected with the corresponding circuit in the electronic device by the feeder cable.

16. The protection method as claimed in claim 14, wherein said assistant plate is made of metal material.

17. The protection method as claimed in claim 14, wherein said protection film is made of dielectric material.

18. The protection method as claimed in claim 14, wherein said assistant plate is flexible to be bent.

19. An antenna used with an electronic device, comprising:
a main body comprising a printed circuit board,
a ground portion formed on the printed circuit board;
a radiation portion extending from said ground portion;
a feeder cable having an inner conductor connected to the radiation portion and an outer conductor connected to the ground portion; and
an extending ground element which is electrically connected to the ground portion for increasing an effective ground area of the antenna and extends beyond a boundary of said printed circuit board opposite to said radiation portion.

20. The antenna as claimed in claim 19, wherein said printed circuit board defines a long side along a lengthwise direction and a short side along a lateral direction perpendicular to said lengthwise direction, and wherein the extending ground element and the radiation portion are respectively located by two sides of the ground portion along said lateral direction.

21. The antenna as claimed in claim 19, wherein said radiation portion includes a large laying L-shaped radiation section and a small lying L-shaped radiation section spaced from each other and respectively extending from said ground portion.
